(19) United States
(12) Patent Application Publication
(10) Pub. No.: US 2008/0079232 A1
(43) Pub. Date: Apr. 3, 2008

(54) Apparatus and method for sealing a pivot axle and bearing assembly during submersion cleaning

(76) Inventors: Lynn Liebschutz, Morgan Hill, CA (US); Jing Fang Pan, Singapore (SG)

Correspondence Address: HITACHI C/O WAGNER BLECHER LLP, 123 WESTRIDGE DRIVE, WATSONVILLE, CA, 95076, US

(21) Appl. No.: 11/542,297

(22) Filed: Oct. 2, 2006

(51) Int. Cl. B60G 7/02

(52) U.S. Cl. 280/124.109; 427/331

(57) ABSTRACT

A method and apparatus for sealing a pivot axle and bearing assembly during submersion cleaning of a head stack assembly with the pivot axle and bearing assembly installed is described. The sealing apparatus includes a pair of caps, one cap for sealing the top of the pivot axle and bearing assembly and a second cap for sealing the bottom of the pivot axle and bearing assembly. The sealing apparatus also includes a retaining device for retaining the pair of caps on the pivot axle and bearing assembly during the submersion cleaning process.

### TECHNICAL FIELD

This invention relates to the field of hard disk drives, and provides a method and apparatus for reducing contaminant transfer in a wet washing operation for cleaning a head stack assembly in a hard disk drive.

### BACKGROUND ART

Hard disk drives are used in almost all computer system operations. In fact, most computing systems are not operational without some type of hard disk drive to store the most basic computing information such as the boot operation, the operating system, the applications, and the like. In general, the hard disk drive is a device which may or may not be removable, but without which the computing system will generally not operate.

The basic hard disk drive model was established approximately 50 years ago and resembles a phonograph. That is, the hard drive model includes a storage disk or hard disk that spins at a standard rotational speed. An actuator arm with a suspended slider is utilized to reach out over the disk. The arm carries a head assembly that has a magnetic read/write transducer or head for reading/writing information to or from a location on the disk. The complete head assembly, e.g., the suspension and head, is called a head gimbal assembly (HGA). Further improvements in capacity have resulted in the creation of a series of HGA's mounted together servicing multiple hard disks. This assembly of HGA's is referred to as a Head Stack Assembly (HSA.)

In operation, the hard disk is rotated at a set speed via a spindle motor assembly having a central drive hub. Additionally, there are tracks evenly spaced at known intervals across the disk. When a request for a read of a specific portion or track is received, the hard disk aligns the head, via the arm, over the specific track location and the head reads the information from the disk. In the same manner, when a request for a write of a specific portion or track is received, the hard disk aligns the head, via the arm, over the specific track location and the head writes the information to the disk. The head gimbal assembly is mounted on a pivot bearing which is in turn mounted to a pivot axle. The axle is fixed to a base in the hard disk drive, and the rotation of the bearing assembly about the pivot axle provides the means for moving the group of head gimbal assemblies forming the head stack assembly across the hard disk.

The steady improvements in disk storage capacity have led to smaller magnetic head sizes and lower fly heights. This decrease in fly height has necessitated that the head stack assembly (HSA) be as clean as possible, to reduce head collisions with asperities that cause loss of read/write functionality or even catastrophic head crashes. Therefore, prior to final assembly in the HDD, the head stack assembly must be thoroughly cleaned. Prior art methods for cleaning a head stack assembly perform the cleaning process without the pivot axle and bearing assembly being installed, and then installing it after the cleaning process. However, improvements in pivot and bearing design have necessitated the use of more permanent installation methods, such as bonding. This more permanent installation has introduced some complications in the cleaning process.

Even though it is possible to selectively clean parts of the HSA, such methods don't provide the level of cleanliness desired for higher reliability and longer lifetime of service. It is possible that un-removed contaminants remaining on the HSA can migrate to cause contamination in other parts of the HDD, particularly during final assembly. When a full wet wash with complete immersion of the HSA in a cleaning solution is used to clean an HSA with bonded pivot and bearing installations, the bearing assembly is at risk for contamination by the cleaning process, because the pivot axle and bearing assembly cannot be closed off completely. There must be a gap between the HSA and the pivot axle to permit the rotation function. Thus, via the gap, contamination can enter into the bearing assembly and grease can wash out of the bearing assembly.

### SUMMARY

An apparatus for sealing a pivot axle and bearing assembly during submersion cleaning of a head stack assembly having the pivot axle and bearing assembly installed is described. The sealing apparatus includes a pair of caps, one cap for sealing the top of the pivot axle and bearing assembly and a second cap for sealing the bottom of the pivot axle and bearing assembly. The sealing apparatus also includes a retaining device for retaining the pair of caps on the pivot axle and bearing assembly during the submersion cleaning.

### BRIEF DESCRIPTION OF THE DRAWINGS

FIG. 1 is a top plan view of a typical hard disk drive.

FIG. 2 is a section view of a typical head stack assembly having two head gimbal assemblies.

FIG. 3 is a section view of a typical pivot axle and bearing assembly.

FIG. 4A is an underside view of a pair of sealing caps employed in accordance with one embodiment of the present invention.

FIG. 4B is a side section view of a pair of sealing caps employed in accordance with an embodiment of the present invention.

FIG. 4C is an underside view of one of a pair of sealing caps in accordance with an embodiment of the present invention.

FIG. 4D is a side section view of an identical pair of sealing caps employed in accordance with an embodiment of the present invention.

FIG. 5 is a section view of an apparatus for sealing a pivot axle and bearing assembly whereby a pair of sealing caps are retained by a screw, according to one embodiment of the present invention.

FIG. 6 is a section view of an apparatus for sealing a pivot axle and bearing assembly whereby a pair of sealing caps are retained by a clip, according to an embodiment of the present invention.

FIG. 7 is a side view of an apparatus for sealing a pivot axle and bearing assembly whereby a pair of sealing caps are retained by an articulated retainer arm, according to one embodiment of the present invention.

FIG. 8 is a flow chart of a method for sealing a pivot axle and bearing assembly that is permanently installed in a head stack assembly, in accordance with one embodiment of the present invention.

FIG. 9 is a block diagram of a pivot axle and bearing assembly sealer, according to one embodiment of the present invention.

### DETAILED DESCRIPTION

Reference will now be made in detail to the alternative embodiment(s) of the present invention. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

The discussion will begin with an overview of an electrical lead suspension (ELS) in conjunction with its operation within a hard disk drive and components connected therewith. The discussion will then focus on embodiments of a method for utilizing a stainless steel framework to change the resonance frequency range of a flexure nose portion of a head gimbal assembly in particular.

In general, embodiments of the present invention provide a method and apparatus for sealing a pivot axle and bearing assembly during submersion cleaning. By providing a seal for the pivot axle and bearing, the cleaning time is significantly reduced while the overall cleaning is significantly increased.

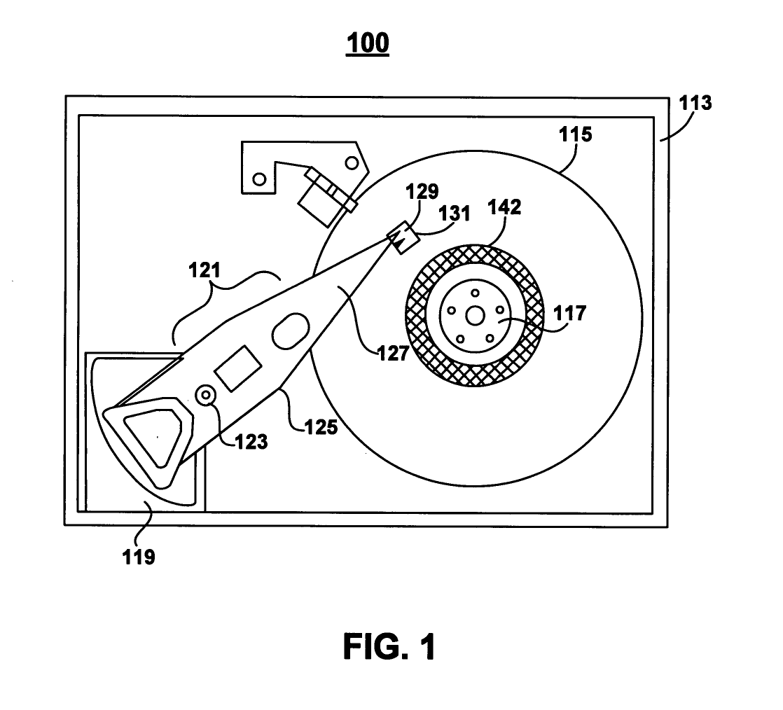

With reference now to FIG. 1, a schematic drawing of one embodiment of an information storage system comprising a magnetic hard disk file or drive (HDD) 100 for a computer system is shown. Embodiments of the invention are well suited for utilization on a plurality of hard disk drives. The utilization of the driver of FIG. 1 is merely one of a plurality of disk drives that may be utilized in conjunction with the present invention.

In the exemplary FIG. 1, HDD 100 has an outer housing or base 113 containing a disk pack having at least one media or magnetic disk 115. Once installed in drive 100, a spindle motor assembly having a central drive hub 117 rotates the disk or disks 115. An actuator comb 121 comprises a plurality of parallel actuator arms 125 (one shown) in the form of a comb that is movably or pivotally mounted to base 113 about a pivot assembly 123. A controller 119 is also mounted to base 113 for selectively moving the comb of arms 125 relative to disk 115. It is understood that controller 119 controls the operation of the disk drive 100 and includes a servo that drives the spindle hub 117. During operation of disk drive 100, its ability to track properly is determined and a servo track error signal is provided via controller 119 for measuring such parameters as positional error and non-repeatable runout (NRRO).

In the embodiment shown, each arm 125 has extending from it at least one cantilevered ELS 127. It should be understood that ELS 127 may be, in one embodiment, an integrated lead suspension (ILS) that is formed by a subtractive process. In another embodiment, ELS 127 may be formed by an additive process, such as a Circuit Integrated Suspension (CIS). In yet another embodiment, ELS 127 may be a Flex-On Suspension (FOS) attached to base metal or it may be a Flex Gimbal Suspension Assembly (FGSA) that is attached to a base metal layer. The ELS may be any form of lead suspension that can be used in a Data Access Storage Device, such as HDD 100. A magnetic read/write transducer 131 or head is mounted on a slider 129 and secured to a flexible structure called “flexure” that is part of ELS 127. The read/write heads magnetically read data from and/or magnetically write data to disk 115.

The level of integration called the head gimbal assembly, or head stack assembly (HSA) when more than one gimbal assembly is employed, is the head and the slider 129, which are mounted on suspension 127. The head gimbal assemblies of the HSA operate in a conventional manner and always move in unison with one another, unless HDD 100 uses multiple independent actuators (not shown) wherein the arms can move independently of one another.

The steady improvements in disk storage capacity have led to smaller magnetic head sizes and lower fly heights. This decrease in fly height has necessitated that the head stack assembly (HSA) be as clean as possible to reduce head collisions with asperities that may cause loss of read/write functionality or even catastrophic head crashes. Therefore, prior to final assembly in the HDD, the head stack assembly must be thoroughly cleaned. Prior art methods for cleaning a head stack assembly perform the cleaning process without the pivot axle and bearing assembly being installed, and then installing it after the cleaning process. However, improvements in pivot and bearing design have necessitated the use of more permanent installation methods, such as bonding. This more permanent installation has introduced a necessity for cleaning the HAS with the pivot axle and bearing assembly installed.

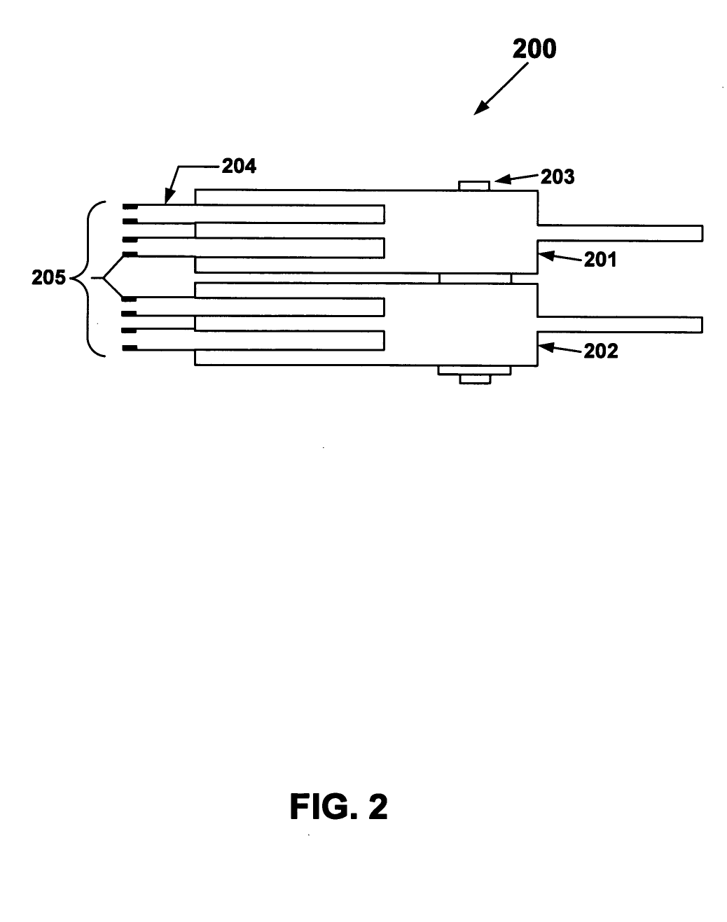

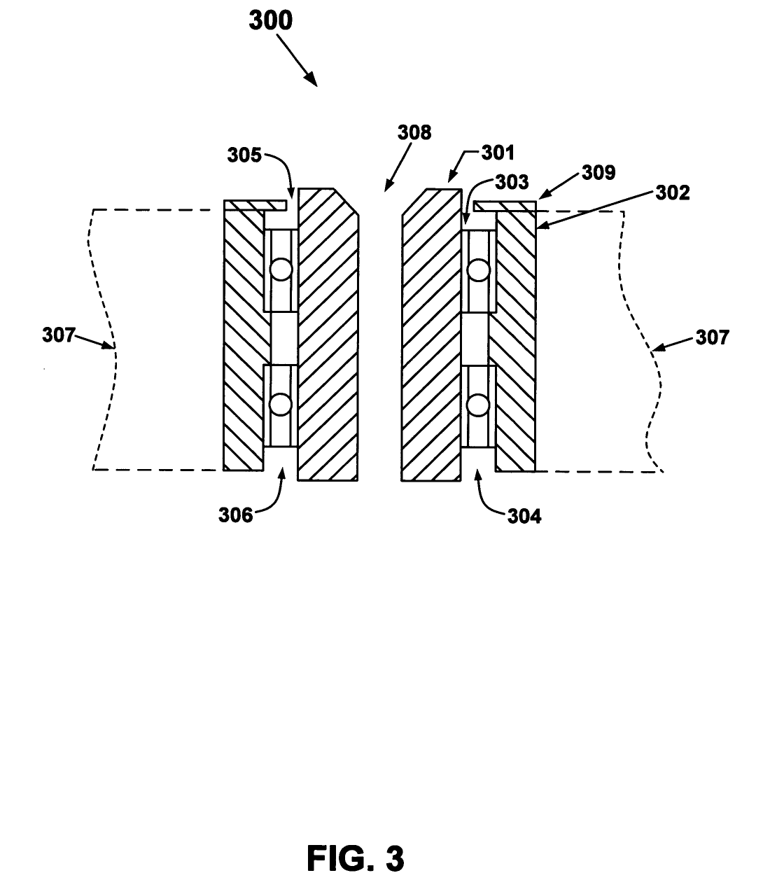

Referring now to FIG. 2, a section view of a conventional head stack assembly 200, having two head gimbal assemblies 201 and 202, is shown. The top 203 of the pivot axle and bearing assembly (e.g., pivot axle and bearing assembly 300 of FIG. 3) which is permanently installed is visible. Prior to inserting HSA 200 into HDD 100, it is necessary to clean it thoroughly to remove any particles and other contaminants that may be present from the manufacturing or repairing process. The best way to clean HSA 200 is to submerge it in a cleaning solution. Although it is possible to selectively clean parts of HSA 200, such methods do not provide the level of cleanliness desired for higher reliability and longer lifetime of service. It is possible that un-removed contaminants remaining on HSA 200 can migrate to cause contamination in other parts of HDD 100, particularly during final assembly.

When a full wet wash with complete immersion of HSA 200 in a cleaning solution is used to clean HAS 200 with bonded pivot axle and bearing assembly installations, the pivot axle and bearing assembly is at risk for contamination by the cleaning process. This is due to the fact that the pivot axle and bearing assembly cannot be closed off completely. There must be a gap between the HSA 200 and the pivot axle to permit the rotation function. Thus, via the gap, contamination can enter into the bearing assembly and bearing grease can wash out of the bearing assembly.

FIG. 3 is a section view of a conventional pivot axle and bearing assembly 300. The pivot axle 301 is shown with a bore hole 308 in the middle. The attachment method for mounting the pivot axle is not shown, but is located at the bottom of the pivot axle. The outer part 302 of the bearing assembly 300 consists of a metal ring, which is bonded to the arm 307 of the head stack assembly 200. A pair of bearing races 303, 304 are installed between the outer ring 302 and the pivot axle 301. The two races move independently but are coupled by ball bearings.

There is a gap 305 at the top between the pivot axle 301 and the inner edge of outer bearing ring 302, partially covered by a thin ring 309, to reduce the size of the gap 305. There is a corresponding gap 306 at the bottom of the bearing assembly. This pair of gaps 305, 306 forms a path for ingress and egress of cleaning solution, allowing the wet wash process to introduce contaminants into the bearing assembly, and possibly remove bearing grease, thus reducing bearing life. Sealing these two gaps 305,306 from the wet wash cleaning fluid provides an effective method for preventing contaminant transfer to and from the bearing assembly.

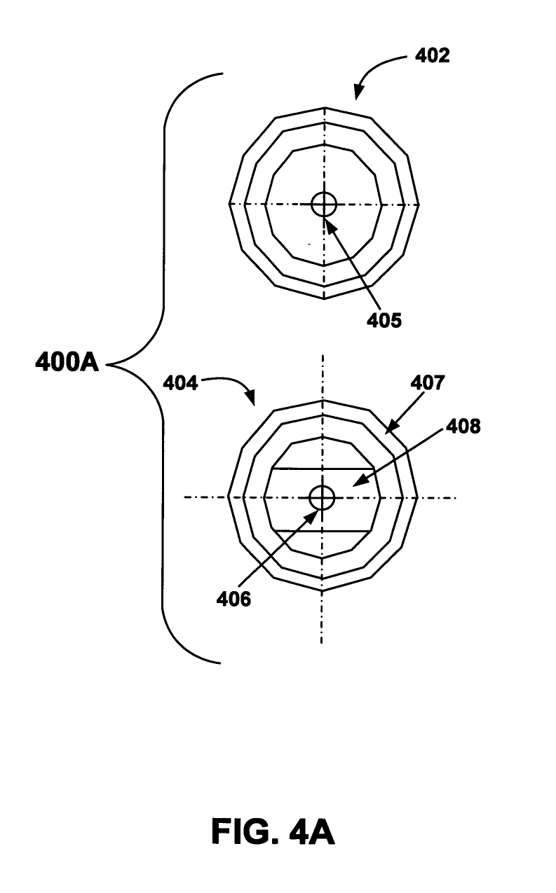

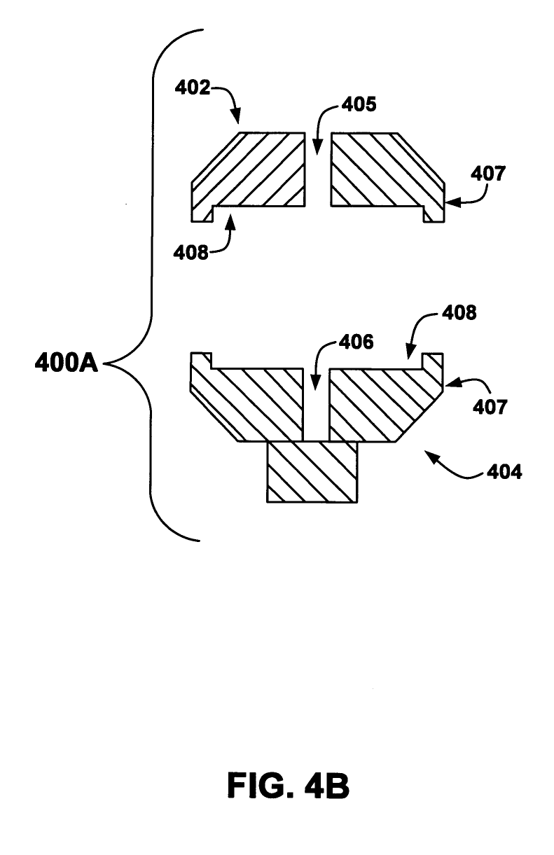

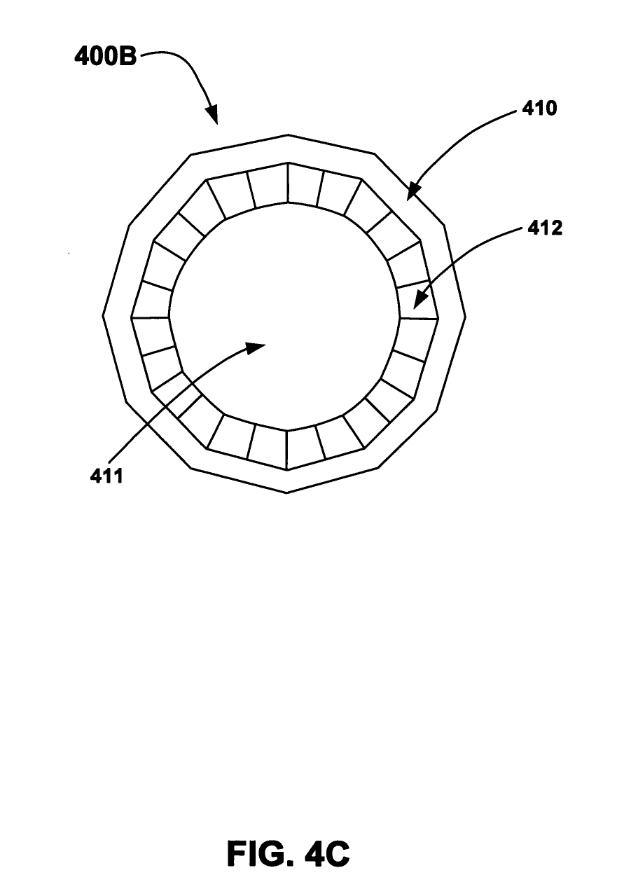

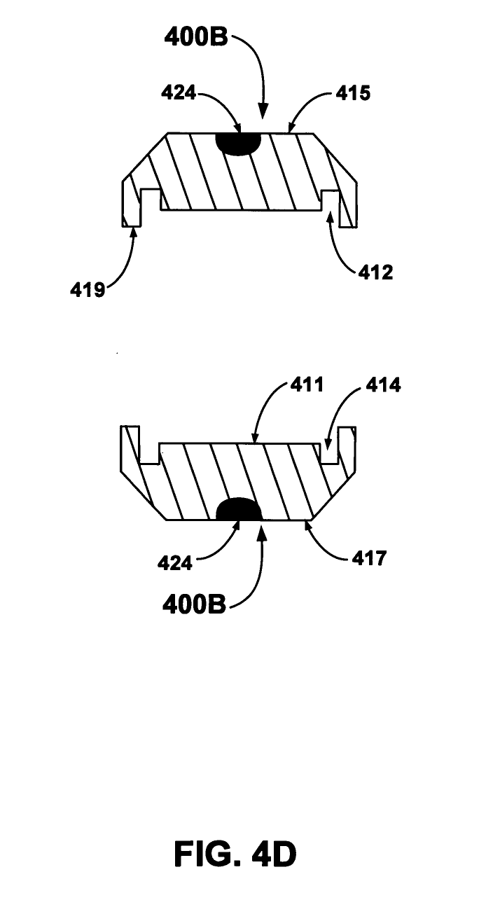

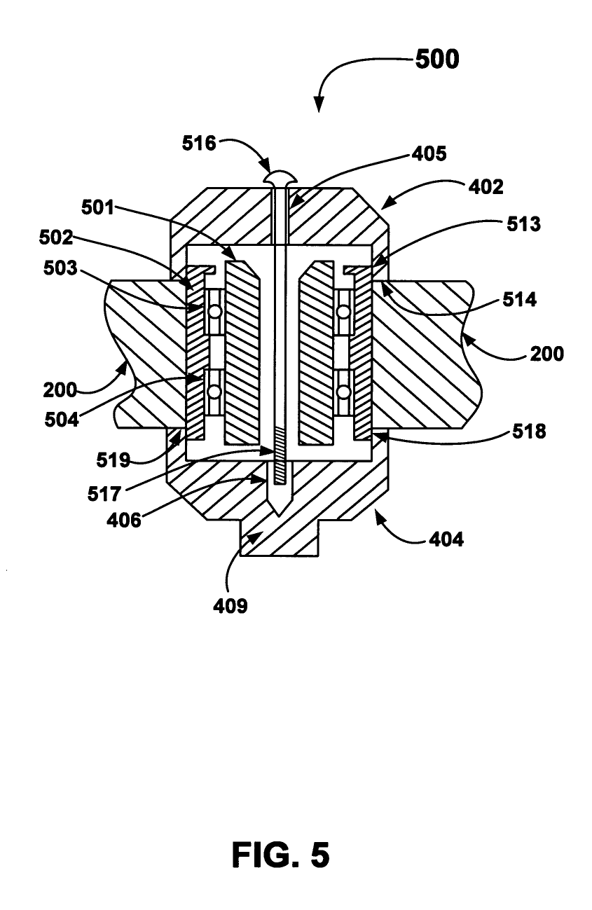

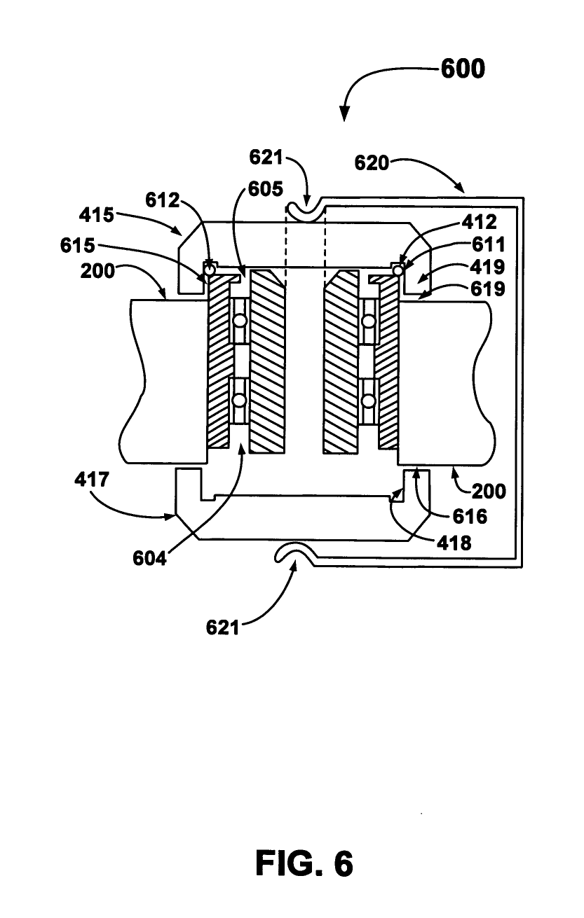

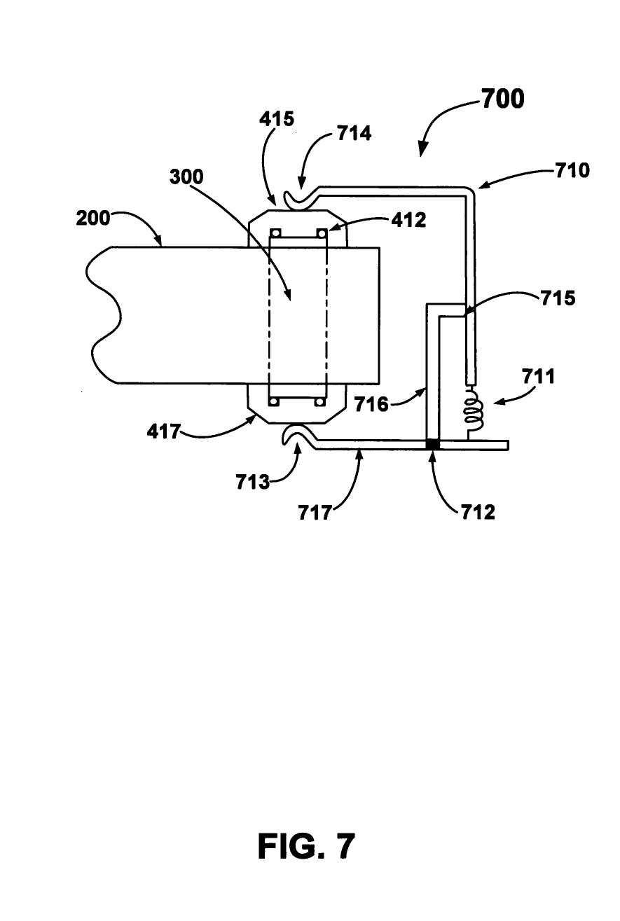

FIGS. 4A through 7 provide various embodiments for isolating the pivot axle and the bearing assembly 300 from cleaning solutions during the wash process. FIGS. 4A and 4B will be discussed in concert with FIG. 5 and FIGS. 4C and 4D will be discussed in concert with FIGS. 6 and 7.

FIG. 5 is a section view 500 of a pivot axle and bearing assembly (e.g., pivot axle and bearing 300) permanently installed in an HAS 200 and having a sealing apparatus installed. A pair of sealing caps 402,404 are retained by a screw 516, according to one embodiment of the present invention. Referring to FIG. 4A, an underside view of the pair of sealing caps 400A, having a top cap 402 and a bottom cap 404 is shown. FIG. 4B is a side section view of the pair of sealing caps 400A. The pair of sealing caps 400A is configured to provide a water tight seal for prevention of contaminant transfer into the pivot axle and bearing assembly during submersion cleaning of the head stack assembly (e.g., HSA 200). Each of the pair of caps has an inside diameter across an inside face 408; and an outside diameter across an outside face 407.

In the present embodiment, the top sealing cap 402 has a penetration 405 to allow a screw-type retaining mechanism 516 to enter the open shaft (e.g., shaft 308 of FIG. 3) through the center of pivot axle and bearing assembly. Bottom sealing cap 404 has a threaded opening 406 to receive a threaded screw or bolt. Screw 516 may be used to join the two caps 402,404 together. The screw 516 passes through penetration 405 in the top cap 402, continues through the open shaft in the pivot axle and bearing assembly, and couples its threaded portion 517 into a threaded hole 406 in the bottom cap 404. The bottom cap 404 has an additional section of material 409 below the end of the threaded opening 406 to provide adequate support for the clamping stress introduced when the two caps 402,404 are clamped together.

Referring still to FIG. 5, a first sealing mechanism is shown where the outer face of top cap 402 seats on the top face of the HSA 200 at joint 514, and where the outer face of bottom cap 404 seats on the bottom face of the HSA 200 at joint 519. The second sealing mechanism is shown at the joints 513, 518 between the outer surface of the bearing ring and the inner wall of inside face 408 (shown in FIG. 4A) of the pair of caps 400A. In this case, the bearing assembly 501 protrudes above and below the HSA 200 arm/actuator, providing the two surfaces 513, 514 needed for the two sealing mechanisms. A first compression joint occurs at 514, 519 in virtue of the clamping force of the screw 516, or from either of the other alternate retaining mechanisms, and a second compression joint occurs at the boundary between the inner wall of inside face 408 of the cap and the outer ring of the bearing assembly at 513 and 518.

In one embodiment of FIG. 5, the outside circumference of inside face 408 of top cap 402 and bottom cap 404 may provide a third sealing mechanism. In this embodiment, a circular recess (e.g., circular recess 412 of FIGS. 4C and 4D) is formed in the inside face 408, the recess being configured to accept an o-ring sealing device. An o-ring placed in recess 412 can provide the third sealing mechanism. FIG. 6 shows this sealing mechanism in greater detail.

Referring now to FIG. 6, a section view of an apparatus 600 for sealing a pivot axle and bearing assembly having a pair of sealing caps retained by a clip is shown, according to an embodiment of the present invention. FIG. 4C is an underside view of one of a pair of sealing caps 400B in accordance with an embodiment of the present invention. FIG. 4D is a side section view of an identical pair of sealing caps 400B. FIG. 6 will be discussed in concert with FIGS. 4C and 4D.

In this embodiment, the top cap 415 and the bottom cap 417 are identical. The top cap 415 is configured to fit over the pivot axle and bearing assembly 300 at the protruding outer ring of the bearing sleeve 615. The cap annular ring 419 is seated on the HSA 200 surface at 619. The bottom cap 417 is configured to fit against HSA surface 200 at 616. The pair of sealing caps 400B is configured to provide a water tight seal for prevention of contaminant transfer into the pivot axle and bearing assembly at gaps 605, 604 during submersion cleaning of HSA 200. Each of the pair of caps has an inside diameter across an inside face 411; and an outside diameter across an outside face 410. The cap may be further configured with a slot or groove 424 in the outside face 410 to receive and contain a retaining device such as a spring clip.

In one embodiment of the present invention, two sealing mechanisms are provided by the cap 400B design. In one embodiment, a first sealing mechanism is provided at the joint 619 between the cap annular ring 419 and the top of the HAS 200 arm/actuator. A similar first sealing joint is provided for the lower cap 417 as shown at 616. This joint achieves its sealing function in virtue of the clamping force from the retaining device 620. A second sealing mechanism is provided at the boundary between the inner wall 418 of the cap 400B and the outer ring of the bearing assembly, shown at 615. The diameter of the inside face 411 of the cap 400B is substantially the same as the diameter of the outer ring of the bearing assembly 302. When the diameter of inside face 411 is the same as the diameter of the outer ring, or slightly smaller, an interference-fit is obtained, which provides a water-tight seal. If the diameter is slightly larger, an adequate seal is obtained in virtue of the slight irregularities in the plastic surface and the length of the boundary joint between the outer ring protrusion and the inner wall 418 of the cap.

According to another embodiment of the present invention, the outside circumference of inside face 411 of top cap 415 and bottom cap 417 may provide a third sealing mechanism. In this embodiment, a circular recess 412 is formed in the inside face 411, the recess being configured to accept an o-ring sealing device. An o-ring 612 placed in recess 412 can provide the third sealing mechanism. The dimensions of the cap height and recess are configured to compress the O-ring slightly when the cap is seated with no gap between the top surface of HSA 200 as shown at 611 (slight gap shown for clarity of cap face boundary.) In the event the bottom of the pivot axle and bearing assembly also protrude from the bottom surface of HSA 200, a second O-ring 612 may also be used to provide a third sealing mechanism for the bottom gap 604 in the pivot axle and bearing assembly. This condition is shown in FIG. 5 at 518, where the bearing assembly outer ring 502 protrudes outside the base of HSA 200. In this case the bottom cap 417 may have an O-ring 612 installed as well.

According to one embodiment, the pair of caps 415, 417 are clamped to the top and bottom surfaces of HSA 200 via a spring clip 620. Clip 620 is configured with coupling interface 621 (top and bottom) to secure clip 620 in place on caps 415,417. In one embodiment, a groove or channel 424 may be provided in the outside face 410 of caps 415,417 at coupling interface 621 to assist in keeping clip 620 in place.

Referring now to FIG. 7, a side view of an apparatus 700 for sealing a pivot axle and bearing assembly is shown, according to another embodiment of the present invention. In the present embodiment a pair of sealing caps 415,417 are retained by an articulated retainer arm 710. The same pivot axle and bearing assembly 300, permanently installed in HSA 200, and having the same caps 415,417 as apparatus 600 of FIG. 6 are employed.

In the present embodiment, the retaining mechanism is comprised of four parts: an upper arm 710 with a gimbal coupling mechanism 714 for coupling to and providing a clamping force to the top cap 415, wherein the upper arm 710 comprises a horizontal portion and a vertical portion; a middle arm 716 is joined to the upper arm at its approximate midpoint at 715; a lower arm 717 joined with a pivot joint 712 to the middle arm 716 also comprising a gimbal coupling mechanism 713 for coupling to and providing a clamping force to the bottom cap 417; and a spring 711 for providing expansion pressure to the pair of arms 710, 717 to provide the clamping force. The spring 711 is located at the lower end of the vertical portion of the upper arm 710 and is coupled to the outer end of the lower arm 717. Pivot joint 712 provides for simple installation and removal of the retaining mechanism to and from the two caps 415,417.

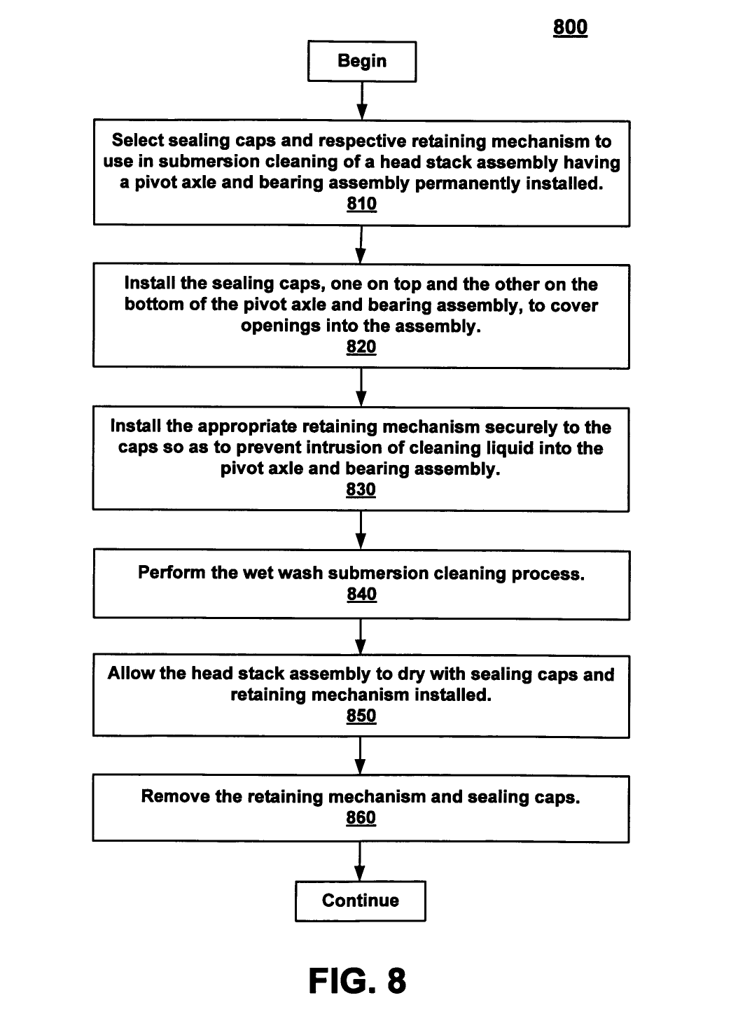

FIG. 8 is a flow chart of a method 800 for sealing a pivot axle and bearing assembly that is permanently installed in a head stack assembly, in accordance with one embodiment of the present invention. Method 800 functions to prevent intrusion of cleaning liquid into the pivot axle and bearing assembly during submersion cleaning of the head stack assembly.

At step 810 of method 800, according to one embodiment of the present invention, a pair of sealing caps and a respective retaining mechanism are selected. The first sealing cap is selected to seal the top of the pivot axle and bearing assembly and the second sealing cap is selected to seal the bottom of the pivot axle and bearing assembly. The retaining mechanism is selected to secure the pair of sealing caps to the pivot axle and bearing assembly.

Still referring to step 810 of method 800, the sealing caps to be selected are either sealing caps configured for a screw-type retaining mechanism as described with FIGS. 4A and 4B above, or sealing caps configured to accept a clip-type mechanism as described with FIGS. 4C and 4D above. The respective retaining mechanisms for the caps of FIGS. 4A and 4B are described with FIG. 5 and for the caps of FIGS. 4C and 4D, with FIGS. 6 and 7.

At step 820 of method 800, the selected sealing caps are installed, one on the top and one on the bottom of the pivot axle and bearing assembly so as to cover the gaps into the assembly, according to one embodiment of the present invention. Once the pivot axle and bearing assembly has been installed in the head stack assembly using permanent bonding techniques, the caps are then installed by hand, and then the compression-based sealing systems are implemented using any of the three cited retaining mechanisms.

At step 830, in accordance with an embodiment of the present invention, the appropriate retaining mechanism is installed securely to the caps, utilizing compression to prevent the intrusion of cleaning liquid into the pivot axle and bearing assembly during the submersion cleaning process. When a screw is used as the retainer, then the caps must be provided with the hole in the top cap and a threaded hole in the bottom cap. When the retaining clips are used, then they are installed after the caps are installed on either end of the bearing assembly.

At step 840, according to one embodiment of the present invention, a wet wash submersion cleaning process is performed on the HSA. The wet wash submersion cleaning process generally involves submersing the HSA in a tank of water with soap or other cleaning solvent and utilizing ultrasonics.

At step 850, in accordance with an embodiment of the present invention, the head stack assembly is allowed to dry with the pair of sealing caps and retaining mechanism installed.

At step 860, the pair of sealing caps and retaining mechanism are removed prior to installation of the HSA in a hard disk drive.

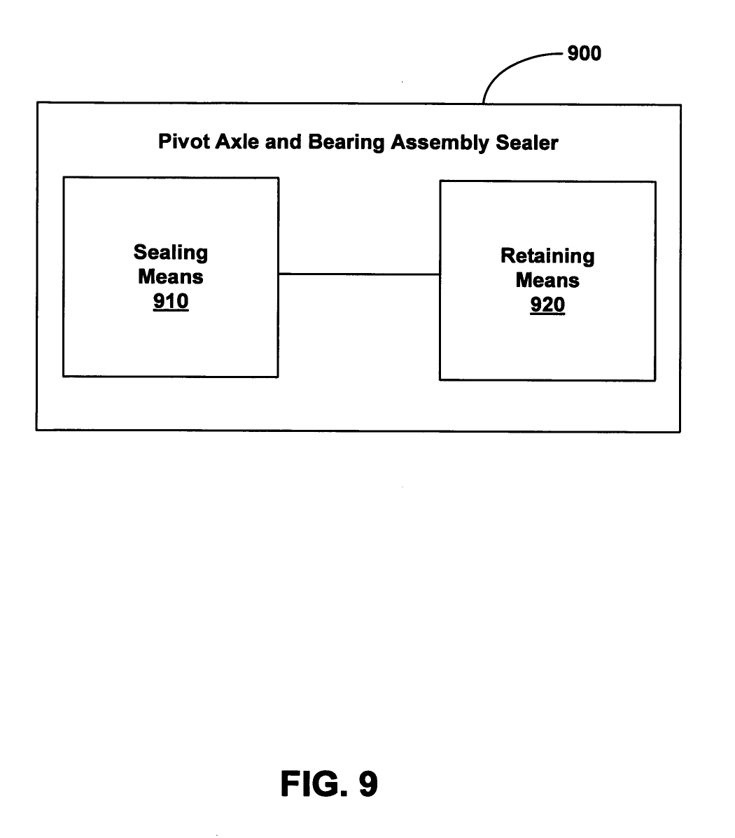

FIG. 9 is a block diagram of a pivot axle and bearing assembly sealer 900, according to one embodiment of the present invention. Pivot axle and bearing assembly sealer 900 has a sealing means 910 for providing a liquid-tight seal for preventing contamination in a pivot axle and bearing assembly during a wet wash process. Coupled to sealing means 910 is a retaining means 920 for securing sealing means 910 to said pivot axle and bearing assembly. Pivot axle and bearing assembly sealer 900 provides at least two sealing mechanisms. These sealing mechanisms are described in detail in conjunction with FIGS. 5-7.

According to one embodiment, sealing means 910 can be a pair of sealing caps, one for sealing the top of a pivot axle and bearing assembly and one for sealing a bottom of the pivot axle and bearing assembly. The pair of sealing caps of sealing means 910 may, in one embodiment, be configured for receiving a screw, as shown in FIGS. 4A and 4B. In another embodiment, sealing means 910 may be a pair of sealing caps configured to receive a retainer arm with clips, as shown in FIGS. 4C and 4D.

Retaining means 920 may be a screw or bolt, according to one embodiment of the present invention. Refer to FIG. 5 for a detailed description of a screw-type retaining means. In another embodiment, retaining means 920 may be a retainer arm and clip as described with FIG. 6. In yet another embodiment, the retaining means 920 may be an articulated arm with a clip. A articulated arm and clip is described with FIG. 7.

Thus, the present invention provides, in various embodiments, an apparatus and method for sealing a pivot axle and bearing assembly during submersion cleaning. The foregoing descriptions of specific embodiments have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. An apparatus for sealing a pivot axle and bearing assembly during submersion cleaning of a head stack assembly, said head stack assembly having said pivot axle and bearing assembly installed, comprising:
a pair of caps, a first cap for sealing a top of said pivot axle and bearing assembly and a second cap for sealing a bottom of said pivot axle and bearing assembly; and
a retaining device coupled to said pair of caps for retaining said pair of caps on said pivot axle and bearing assembly during said submersion cleaning.

2. The apparatus as described in claim 1 wherein said pair of caps is configured to provide a water tight seal for prevention of contaminant transfer into said pivot axle and bearing assembly during said submersion cleaning of said head stack assembly.

3. The apparatus as described in claim 1 wherein each of said pair of caps comprises:
an inside diameter;
an outside diameter;
an inside face; and
an outside face.

4. The apparatus as described in claim 3 wherein said outside face is configured to couple with said retaining device for holding each said pair of caps in place when said pair of caps and said retaining device are installed on said pivot axle and bearing assembly.

5. The apparatus as described in claim 4 wherein said pair of caps are further configured to provide at least two sealing mechanisms.

6. The apparatus as described in claim 5, wherein an outside circumference of said inside face of said first cap comprises a circular recess, said recess configured to accept an o-ring sealing device.

7. The apparatus as described in claim 6, wherein said first cap comprises an o-ring in said recess.

8. The apparatus as described in claim 5, wherein said retaining device comprises a screw.

9. The apparatus as described in claim 8, wherein said screw is configured to penetrate a central hole in said first cap and thread into a central threaded hole in said second cap via a shaft through the center of said pivot and axle assembly.

10. The apparatus as described in claim 5, wherein said retaining device comprises a retaining clip, said retaining clip configured to clip onto said outside face of each of said pair of caps.

11. The apparatus as described in claim 5, wherein said retaining device comprises an articulated retainer arm, said retainer arm comprising:
a spring;
a pivot; and
a pair of gimbaled clip ends.

12. A method for sealing a pivot axle and bearing assembly, said pivot axle and bearing assembly installed in a head stack assembly, to prevent intrusion of cleaning liquid into said pivot axle and bearing assembly during submersion cleaning of said head stack assembly, said method comprising:
receiving a pair of sealing caps and a respective retaining mechanism, a first of said pair of sealing caps for sealing a top area and a second of said pair of sealing caps for sealing a bottom area of said pivot axle and bearing assembly, said retaining mechanism for securing said pair of sealing caps to said pivot axle and bearing assembly;
installing said selected pair of sealing caps and said respective retaining mechanism on said pivot axle and bearing assembly;
performing a wet wash process on said head stack assembly;
allowing said head stack assembly to dry with said pair of sealing caps and retaining mechanism installed; and
removing said pair of sealing caps and retaining mechanism prior to installation of said head stack assembly in a hard disk drive.

13. The method recited in claim 12 wherein said selecting a pair of sealing caps and a respective retaining mechanism, a first of said pair of sealing caps to seal a top area and a second of said pair of sealing caps to seal a bottom area of said pivot axle and bearing assembly, and said retaining mechanism to secure said pair of sealing caps to said pivot axle and bearing assembly further comprises:
selecting said retaining mechanism comprising a screw, said screw configured to penetrate said first of said pair of sealing caps and a shaft through said pivot axle and bearing assembly and screw into a threaded portion of said second of said pair of sealing caps.

14. The method recited in claim 12 wherein said selecting a pair of sealing caps and a respective retaining mechanism, a first of said pair of sealing caps to seal a top area and a second of said pair of sealing caps to seal a bottom area of said pivot axle and bearing assembly, and said retaining mechanism to secure said pair of sealing caps to said pivot axle and bearing assembly further comprises:
selecting said retaining mechanism comprising a retaining clip, said retaining clip configured to clip onto an outside face of each of said pair of sealing caps.

15. The method recited in claim 12 wherein said selecting a pair of sealing caps and a respective retaining mechanism, a first of said pair of sealing caps to seal a top area and a second of said pair of sealing caps to seal a bottom area of said pivot axle and bearing assembly, and said retaining mechanism to secure said pair of sealing caps to said pivot axle and bearing assembly further comprises:
selecting said retaining mechanism comprising an articulated retainer arm configured to clip onto an outside face of each of said pair of sealing caps.

16. A pivot axle and bearing assembly sealer comprising:
a sealing means for providing a liquid-tight seal for preventing contamination in a pivot axle and bearing assembly during a wet wash process; and
a retaining means coupled to said sealing means, said retaining means for securing said sealing means to said pivot axle and bearing assembly.

17. The pivot axle and bearing assembly sealer of claim 23 further comprising at least two sealing mechanisms.

18. The pivot axle and bearing assembly sealer of claim 23 wherein said sealing means comprises a pair of sealing caps, a first of said pair of sealing caps for sealing a top of said pivot axle and bearing assembly and a second of said pair of sealing caps for sealing a bottom of said pivot axle and bearing assembly.

19. The pivot axle and bearing sealer of claim 23 wherein said retaining means comprises a screw.

20. The pivot axle and bearing sealer of claim 23 wherein said retaining means comprises a retainer arm and clip.

21. The pivot axle and bearing sealer of claim 23 wherein said retaining means comprises an articulated arm and clip.
